(19) United States
(12) Patent Application Publication
(10) Pub. No.: US 2026/0084386 A1
(43) Pub. Date: Mar. 26, 2026

(54) TOOLING FOR PRESSURIZING A WORK ZONE OF A PART MADE OF COMPOSITE MATERIAL, ROBOT EQUIPPED WITH SUCH TOOLING AND METHOD FOR REPAIRING SUCH A PART MADE OF COMPOSITE MATERIAL USING SUCH TOOLING

(71) Applicant: SAFRAN NACELLES, GONFREVILLE-L'ORCHER (FR)

(72) Inventors: Arnaud MARICAL, MOISSY-CRAMAYEL (FR); Julien HELIN, MOISSY-CRAMAYEL (FR); Nicolas DEZEUSTRE, MOISSY-CRAMAYEL (FR)

(73) Assignee: SAFRAN NACELLES, GONFREVILLE-L'ORCHER (FR)

(21) Appl. No.: 19/112,075

(22) PCT Filed: Sep. 20, 2023
(86) PCT No.: PCT/FR2023/051442

§ 371 Date: Mar. 14, 2025

(30) Foreign Application Priority Data
Sep. 21, 2022 (FR) 2209552

(51) Int. Cl. B29C 73/12; B29K 105/08

(52) U.S. Cl. CPC B29C 73/12; B29K 2105/0872

(57) ABSTRACT

A tooling pressurizes a work zone of a part made of composite material. The composite material includes a fiber reinforcement densified by a resin and pre-impregnated applied in the work zone. The pressurizing tooling is configured to be removably mounted on a robot and includes an articulated skeleton configured to adapt to the shape of the part around the work zone. The pressurizing tooling further includes at least one inflatable membrane which is secured to the skeleton and which is configured to apply, in an inflated state, a predetermined and uniform pressure to the work zone.

### FIELD OF THE INVENTION

This invention relates to the repair or manufacture of a part made of composite material comprising a fibrous reinforcement, in particular with pre-impregnated fibers with a resin.

### TECHNICAL BACKGROUND

The prior art comprises documents US-A1-2011/259515, US-A1-2021/379845 and US-B1-6318433.

Many parts used in different sectors such as the automotive and aerospace industries comprise parts made of composite material. The composite materials allow the production of lightweight parts with high mechanical characteristics. When the fibrous reinforcement is made from pre-impregnated fibers with a resin, these can be used to produce parts of any size and with a complex three-dimensional shape.

The parts made of composite material can sometimes be damaged during manufacture, operation, maintenance or storage, for example as a result of impact. The parts made of composite material can be repaired when the damaged zone is limited. The same types of materials are used, in particular pre-impregnated fibers with a resin or dry fibers impregnated by hand.

The densification of resin-impregnated fibers requires a polymerization phase, which is generally carried out in an autoclave. In fact, an autoclave allows a thermal cycle and a pressure cycle to be applied, the purpose of which is to compact the fibers to keep them in position on the part made of composite material to be repaired, to gel the resin that impregnates the fibers and to obtain a good resin/fiber ratio. Autoclaves are large and expensive tools installed in workshops where parts made of composite material are manufactured and/or repaired.

One of the disadvantages is that the parts have to be dismantled and transported to these workshops. Furthermore, not all workshops are equipped with large autoclaves, which are expensive, so some autoclaves cannot accommodate very large parts.

It is possible to repair parts made of composite material that are still fitted to the equipment, i.e. without autoclaving. During such a repair, the pre-impregnated fibers with a resin are placed over the damaged zone and covered by a bladder that is connected to the part made of composite material in a sealed manner and allows the damaged zone to be vacuumed. However, the pressure parameters allowing parts with high mechanical strength to be obtained are not reached because the vacuum of the bladder limits the pressure applied to the atmospheric pressure of the zone where the repair is carried out, as well as the capacity of the vacuum pump used. For example, the pressure exerted on the pre-impregnated fibers is less than 1 bar, which is not sufficient to achieve the desired thermomechanical properties for the part.

There is a need to resolve some or all of the above disadvantages.

### SUMMARY OF THE INVENTION

The aim of the present invention is to provide a solution for polymerizing a part made of composite material with at least adequate pressure, anywhere, autonomously and quickly.

This is achieved in accordance with the invention by means of a tooling for pressurizing a work zone of a part made of composite material, the composite material comprising a fibrous reinforcement densified by a resin, pre-impregnated fibers being applied in the work zone and the pressurizing tooling being configured so as to be removably mounted on a robot, the pressurizing tooling comprising an articulated skeleton configured so as to adapt to the shape of the part around the work zone, and at least one inflatable membrane which is secured to the skeleton and which is configured to apply, in an inflated state, a predetermined and uniform pressure to the work zone.

Thus, this solution allows to achieve the above-mentioned objective. In particular, the use of such tooling enables a specific and uniform pressure to be applied to the entire work zone of the part made of composite material. The configuration of the tooling means that it can be used in any workshop, or even under the wing in the case of an aircraft, with all the characteristics of an autoclave. This reduces the need to transport parts from one place to another, and means that energy and human resources are spent on just what is needed. In addition to this, this tooling allows us to respond to the ecological challenge by avoiding the transportation of bulky and fragile parts for repair and by avoiding waste by repairing damaged parts.

The pressurizing tooling also comprises one or more of the following characteristics, taken alone or in combination:
the pressurizing tooling comprises a heating system mounted on the inflatable membrane so as to apply a predetermined temperature.
the articulated skeleton comprises a plurality of segments which are articulated together.
the inflatable membrane is connected to an inflation fluid supply source.
the inflatable membrane has a height of between 2 and 5 cm in its inflated state inflated.
the fluid supply source is either built into the pressurizing tooling or portable.
the electrical energy source is onboard the pressurizing tooling or portable.
the pressurizing tooling comprises an attachment system for the removable attachment to a robot.
the pressure and temperature applied to the work zone are constant during the polymerization stage.
the pressure applied to the work zone is uniform.
the temperature applied to the work zone is between 60° and 180° C.

The invention also relates to a collaborative robot comprising a chassis, an arm which is carried by the chassis and an end effector connected to the arm in a removable manner, the end effector being intended to be moved by the arm and being formed by the pressurizing tooling as aforesaid.

The invention further relates to a method of repairing a damaged zone of a part made of composite material, the composite material comprising a fibrous reinforcement densified by a resin, the repair method comprising:
a step of applying pre-impregnated fibers with a resin to the damaged zone forming a work zone, and
a step of vacuuming an internal cavity formed by a bladder covering the pre-impregnated fibers in the work zone in a sealed manner,
   the method comprising
a step of placing a pressurizing tooling having any one of the aforementioned characteristics with respect to the pre-impregnated fibers covered by the bladder, and
a step of polymerizing the pre-impregnated fibers, wherein at least one sub-step of applying a predetermined and uniform pressure by the inflatable membrane to the bladder covering the pre-impregnated fibers is carried out.

The method also comprises one or more of the following characteristics and/or steps, taken alone or in combination:
the predetermined pressure is between 1 bar and 3 bar.
the polymerization step comprises a sub-step of applying a predetermined temperature.
the predetermined temperature is between 60° C. and 180° C.
the method comprises a step of applying counter-pressure to the part made of composite material.
the counter-pressure is carried out by another pressurizing tooling.
the predetermined temperature application is carried out by the two pressurization tooling which are arranged on either side of the part made of composite material.
the pressure and temperature applied to the work zone are controlled during the polymerization stage.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is a schematic side view of an example of a pressurizing tooling fitted with a collaborative robot according to the invention;

FIG. 2 is a schematic top view of an example of the embodiment of a member of the pressurizing tooling according to the invention;

FIG. 3 is a perspective view of two collaborative robots used to repair a part made of composite material according to the invention.

### DETAILED DESCRIPTION OF THE INVENTION

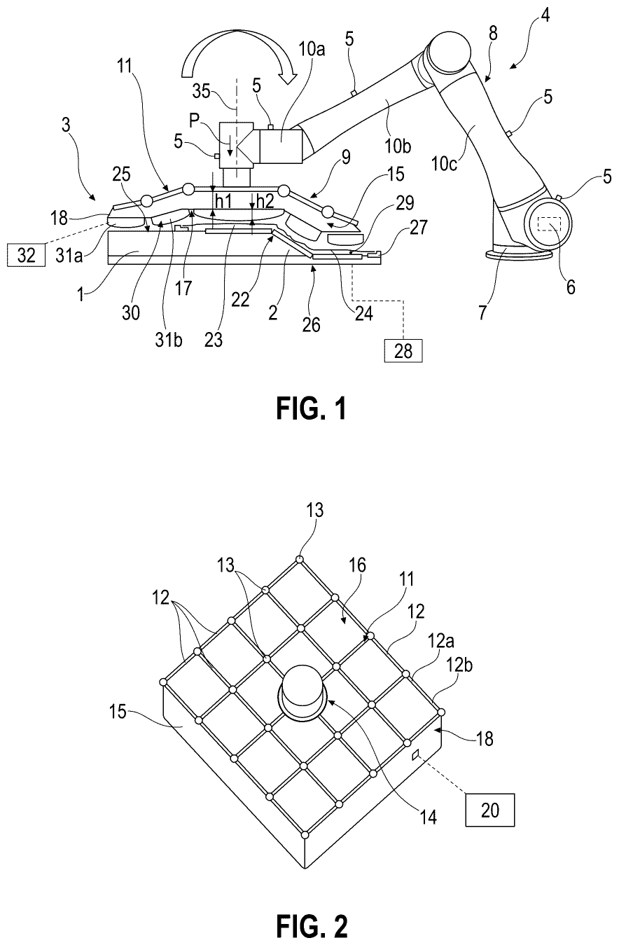

FIG. 1 partially represents a part made of composite material. The composite material comprises a fibrous reinforcement densified by a resin. More specifically, the fibrous reinforcement is made up of several folds of pre-impregnated fibers with a resin. The part made of composite material can be fitted to a motor vehicle, an aircraft, a turbomachine nacelle for an aircraft, etc.

In FIG. 1, the part made of composite material comprises a damaged zone that needs to be repaired. This damaged zone forms a working zone 2. To this end, a pressurizing tooling 3 is also shown in FIG. 1 and is designed to facilitate the repair of the work zone 2.

The pressurizing tooling 3 is configured so as to equip a robot 4, in particular a collaborative robot, which is also illustrated in FIG. 1. The collaborative robots are equipped with detection means 5 and an electronic control system 6 to which the detection means 5 are connected to enable it to move and/or evolve in its working environment. Each robot 4 is designed to carry out specific tasks alone (autonomously) or in cooperation with one or more operators or with other collaborative robots also operating in the robot's working environment. The tasks are for example manipulations, repairs, moving or other tasks that may be more detailed. These collaborative robots are also known as “cobot”.

Advantageously, but not limitedly, the detection means 5 may be presence sensors, position sensors, cameras, measuring means, etc. and/or a combination of these means. The detection means 5 are mounted on different units of the robot 4.

Advantageously, the electronic control system 6 is equipped with calculation means, memories and information processing means enabling the robot 4 to act and/or react according to the information received from the detection means 5.

The robot 4 comprises a chassis 7, an arm 8 supported by the chassis 7 and an end effector 9 detachably connected to the arm 8. The detection means 5 can be mounted on the end effector 9 and/or the arm 8 and/or the chassis 7.

Advantageously, the chassis 7 is mounted on movement means (not shown) so that the robot 4 can move autonomously in its working environment. Alternatively, the chassis is configured so that it can be fixed to a work support.

Advantageously, but without limitation, the arm 8 comprises several portions 10a, 10b, 10c which are articulated to each other via, for example, pivot connections with different axes or ball-and-socket connections so that the end effector 9 can be easily manipulated in several directions.

The end effector 9 is designed to perform the various tasks for which the robot 4 is used. The end effector 9 represents the head of the robot and is advantageously formed here by the pressurizing tooling 3.

With reference to FIGS. 1 and 2, the pressurizing tooling 3 comprises an articulated skeleton 11 which is configured to adapt to the shape of the work zone 2. By the term “articulated skeleton” we mean an organ made up of several elements that are articulated together so that the organ is deformable.

In this example, the skeleton 11 comprises several segments 12 articulated together along at least one joint 13. The latter 13 can be at least one pivot link. In particular, the segments 12 are arranged to form a grid and at least one end 12a, 12b of each segment 12 is hinged to one end 12a, 12b of an adjacent segment. The segments that delimit the perimeter can form a square, a rectangle or any other shape that allows the segments to be articulated and the skeleton 11 to be deformed in relation to the work zone of the part.

An advantageous but non-limiting characteristics is that the various hinges 13 can be locked in a suitable position to hold the membrane 15 described later in compression.

The pressurizing tooling 3 also comprises a membrane 15 which is configured to apply a predetermined and uniform pressure to the work zone 2. The membrane 15 is inflatable. The membrane 15 is adapted to occupy a deflated state and an inflated state. The inflatable membrane 15 is shown in its inflated state in FIG. 1. Advantageously, the membrane 15 is secured to the skeleton 11 to make it easier to handle the tooling 3 and save repair time. The predetermined pressure is advantageously applied in the inflated state so that the pressure is uniform in the membrane.

To do this, the inflatable membrane 15 is connected to an inflation fluid supply source 20. The supply source 20 is shown schematically in FIG. 2. The inflation fluid can be air or oil or any other liquid or gaseous fluid. The fluid supply source 20 may comprise a pump or a compressor. Similarly, the fluid supply source 20 can be on-board the pressurizing tooling 3 and/or the collaborative robot 4. In this way, the supply source 20 can be easily moved with the pressurizing tooling and/or the collaborative robot so that the repair can be carried out anywhere, for example, under the wing in an aircraft part or in a workshop.

Advantageously, but without limitation, the membrane 15 has an external surface with a perimeter substantially equal to that of the skeleton 11 so that the pressure is better distributed over the entire wall of the membrane 15. In particular, the membrane 15 has a first wall 16 and a second wall 17 which are opposite each other. The two walls 16, 17 are connected by a peripheral edge 18 delimiting the perimeter of the membrane 15. The first wall 16 is connected to the skeleton 11. The connection can be made by gluing or any other means. The second wall 17 is designed to face the work zone 2.

The predetermined pressure is typically between 1 bar and 10 bar. Preferably the predetermined pressure is 2.5 bar.

An advantageous characteristic is that in its inflated state, the membrane 15 has a height h1 typically between 2 cm and 5 cm. It is also possible to have heights greater than this value. The height h1 is measured between the first wall 16 and the second wall 17.

The inflatable membrane 15 is advantageously made of a flexible and/or supple material. The material can be, for example, a polymer such as polyethylene (PE), polyethylene terephthalate (PET), polypropylene (PP), an elastomer or similar.

Also in FIG. 1, the pressurizing tooling 3 comprises a heating system 30 mounted on the inflatable membrane 15 so as to apply a predetermined temperature. Preferably, the heating system 30 is attached to the inflatable membrane. In this example, the heating system 30 comprises several heating elements 31a, 31b, . . . which are distributed over the entire second wall 17 of the inflatable membrane.

Advantageously, but without limitation, the heating members 31a, 31b have a height h2 of between 1 mm and 5 mm and preferably between 1 mm and 2 mm. The heating system 30 is connected to a source of electrical energy 32. As with the fluid supply source, the electrical energy source 32 can be carried on board the pressurizing tooling 3 and/or the collaborative robot, or can be easily transported to facilitate repair of the part made of composite material anywhere.

The predetermined temperature is advantageously between 60° and 180° C.

Referring to FIG. 2, the pressurizing tooling 3 is fitted with an attachment system 14 that allows it to be removably attached to the robot arm.

This pressurizing tooling 3 is particularly suitable for repairing damaged zone of a part made of composite material and also for manufacturing a part made of composite material.

We will now describe a method for repairing a part made of composite material. The method comprises the following steps:
applying pre-impregnated fibers 22 of resin in the work zone,
vacuuming an internal cavity 23 formed by a bladder 24 covering in a sealed manner the pre-impregnated fibers 22 in the work zone,
positioning a portable pressurizing tooling 3 opposite the pre-impregnated fibers covered by the bladder, and
a step of polymerizing the pre-impregnated fibers, wherein at least one sub-step of applying a predetermined and uniform pressure by the inflatable membrane to the bladder covering the pre-impregnated fibers is carried out.

With reference to FIG. 1, the method comprises a step of preparing the work zone 2 prior to applying the pre-impregnated fibers. The latter is located on a first surface 25 of the part made of composite material. The part made of composite material comprises a second surface 26 opposite the first surface.

The preparation step comprises removing the folds and/or fibers from the work zone 2 that are no longer in cohesion with the other folds and/or fibers of the part made of composite material. In other words, this preparation step involves cleaning the work zone 2.

During the step of applying the resin pre-impregnated fibers 22, the fibers are applied in the form of several folds one by one. Advantageously, but not restrictively, the folds can be produced using a two-dimensional (2D) weave. The pre-impregnated fibers comprise, for example, fibers made of carbon, glass, polyamide, Kevlar, ceramic, copper, bronze or a mixture of these materials.

The fibers are pre-impregnated in an earlier stage (they are supplied already pre-impregnated) or they are dried and impregnated just before being placed on the work zone with a resin. The term “pre-impregnated” then refers to the fibers that have already been impregnated with resin before the step of applying the fibers.

The resin is capable of withstanding high temperatures, in particular temperatures in excess of 120° C. This type of resin allows a composite material with high mechanical performance to be obtained. An example of a resin is an epoxy-based thermosetting resin or a phenolic resin such as polybismaleimides (BMI).

The method includes a step wherein the bladder 24 is positioned to cover the pre-impregnated fibers 22 in a sealed manner. The bladder 24 forms the internal cavity 23 in which the pre-impregnated fibers 22 are located. The bladder 24 also covers a portion of the first surface 25 surrounding the pre-impregnated fibers. The bladder 24 is in the form of a skin which is soft and flexible. The bladder 24 is removably attached to the first surface in a sealed manner. In particular, the bladder 24 has an edge which is attached to the first surface 25. The attachment is carried out by any means allowing a sealing of the bladder, an installation as well as an easy removal.

Advantageously, but without limitation, a gasket 27 is provided at the attachment to prevent air or other fluid from entering the internal cavity 23 formed by the bladder 24 and the first surface 25 of the part made of composite material. Advantageously, the gasket 27 is made of a deformable material.

The vacuumization step of the bladder 24 is carried out by a vacuumization device 28 which allows the extraction of the air or gas present in the internal cavity 23. The bladder 24 in fact comprises a suction orifice 29 which is connected to the vacuum device 28. The latter advantageously comprises a vacuum pump or compressor.

The polymerization step comprises the application of at least one predetermined and uniform pressure by the inflatable membrane 15. To apply this pressure, the membrane 15 is inflated with the inflation fluid. The skeleton 11 that presses on the inflatable membrane 15 allows the latter to distribute pressure evenly over the entire work zone 2. The pressure is oriented in a direction parallel to the vertical axis in the plane shown in FIG. 1. Here, the direction is parallel to the axis 35 of the attachment system 14 of the tooling 3. The pressure is directed towards work zone 2. Advantageously, the (controlled) pressure is constant during the polymerization stage.

During the step of positioning the tooling 3 opposite the work zone and the pre-impregnated fibers, the articulated skeleton 11 is positioned at a distance from the pre-impregnated fibers (in particular the bladder) so that when the membrane 15 is inflated, it is in contact with the bladder 24. The predetermined distance is between 1 and 3 cm from the first surface 25. The heating members 31a, 31b of the heating system 30 are positioned between the inflatable membrane 15 and the bladder 24.

The polymerization step also comprises applying a predetermined temperature to the pre-impregnated fibers. This temperature is applied by the heating members 31. The predetermined (controlled) temperature is also constant during the polymerization stage.

The pressure required for polymerization is supplied by a single pressurizing tooling (the head of a collaborative robot) including at least one inflatable membrane 15 which allows the pressure to be applied uniformly and homogeneously. The temperature and pressure allow the pre-impregnated fiber folds to be densified.

The method as described can also be used to manufacture a part made of composite material.

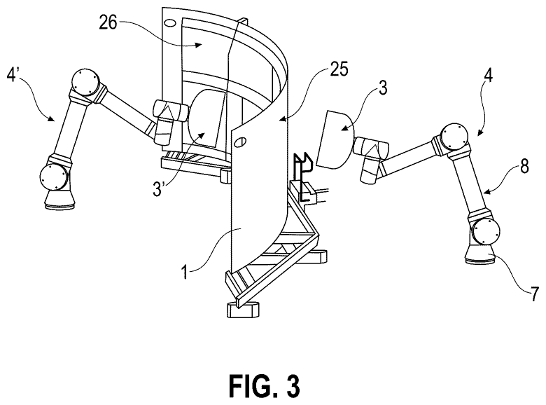

FIG. 3 shows another embodiment of the repair or manufacturing method for the part made of composite material. This embodiment is particularly implemented in the context of a very flexible part made of composite material. In this embodiment, the method comprises a further step of applying counter-pressure to the part made of composite material. More specifically, the counter-pressure is applied to the second surface 26 in the work zone. This configuration ensures that the part is held in position and prevents the part made of composite material from deforming. Advantageously, but not exclusively, the counter-pressure is carried out by another pressurizing tooling 3′. This would preferably be carried by an another collaborative robot 4′.

In one embodiment, the predetermined temperature is applied by the two pressurization tooling 3, 3′ arranged on either side of the part made of composite material 1. This ensures good heat diffusion and distribution in the case of a thick part of composite material. The fact that it is so thick means that the part is not flexible and presents problems of temperature diffusion. The polymerization of the pre-impregnated fibers is homogeneous and is therefore accelerated.

1. A tooling for pressurizing a work zone of a part made of composite material, the composite material comprising a fibrous reinforcement densified by a resin pre-impregnated fibers being applied in the work zone and the pressurizing tooling being configured so as to be removably mounted on a robot, the pressurizing tooling comprising:
articulated skeleton configured to adapt to a shape of the part around the work zone, and
at least one inflatable membrane secured to the skeleton and configured to apply, in an inflated state, a predetermined and uniform pressure to the work zone.

2. The pressurizing tooling according to claim 1, further comprising a heating system mounted on the inflatable membrane so as to apply a predetermined temperature.

3. The pressurizing tooling according to claim 1, wherein the articulated skeleton comprises a plurality of segments which are articulated together.

4. The pressurizing tooling according to claim 1, wherein the inflatable membrane is connected to an inflation fluid supply source.

5. The pressurizing tooling according to claim 1, wherein the inflatable membrane has a height of between 2 and 5 cm in its inflated state.

6. The pressurizing tooling according to claim 1, further comprising an attachment system for removable attachment to a collaborative robot.

7. The collaborative robot according to claim 6, comprising a chassis, an arm which is carried by the chassis, and an end effector removably connected to the arm, the end effector being configured to be moved by the arm and being formed by the pressurizing tooling.

8. A method of repairing a damaged zone of a part made of composite material, the composite material comprising a fibrous reinforcement densified by a resin, the repair method comprising steps of:
applying pre-impregnated fibers with a resin to the damaged zone forming a work zone,
vacuuming an internal cavity formed by a bladder covering the pre-impregnated fibers in the work zone in a sealed manner,
placing the pressurizing tooling according to claim 1 opposite the pre-impregnated fibers covered by the bladder, and
polymerizing the pre-impregnated fibers, wherein at least one sub-step of applying a predetermined and uniform pressure by the inflatable membrane to the bladder covering the pre-impregnated fibers is carried out.

9. The repair method according to claim 8, wherein the predetermined pressure is between 1 bar and 3 bar.

10. The repair method according to claim 8, wherein the polymerization step comprises a sub-step of applying a predetermined temperature.

11. The repair method according to claim 10, wherein the predetermined temperature is between 60° C. and 180° C..

12. The repair method according to claim 11, further comprising a step of applying counter-pressure to the part made of composite material.

13. The repair method according to claim 12, wherein the counter-pressure is carried out by another pressurizing tooling.

14. The repair method according to claim 13, wherein the predetermined temperature application is carried out by the two pressurizing toolings, which are arranged on either side of the part made of composite material.

15. The repair method according to claim 10, wherein the pressure and temperature applied to the work zone are controlled during the polymerization step.
